(19) United States
(12) Patent Application Publication
(10) Pub. No.: US 2012/0050695 A1
(43) Pub. Date: Mar. 1, 2012

(54) VIDEO PROJECTOR

(75) Inventor: Shinya Noda, Neyagawa-shi (JP)

(73) Assignee: SANYO ELECTRIC CO., LTD., Osaka (JP)

(21) Appl. No.: 13/213,659

(22) Filed: Aug. 19, 2011

(30) Foreign Application Priority Data
Aug. 27, 2010 (JP) 2010-191195

(51) Int. Cl. G03B 21/16

(52) U.S. Cl. 353/61

(57) ABSTRACT

A video projector including a housing, a duct and a deflector. The housing accommodates a plurality of cooling subjects. The duct guides air, which is drawn into the housing, to a predetermined cooling subject. Cooling current is discharged out of the duct to cool the predetermined cooling subject. The deflector deflects the cooling current after cooling the predetermined cooling subject toward a further cooling subject. The deflector is a sound absorbing material.

### CROSS-REFERENCE TO RELATED APPLICATIONS

This application is based upon and claims the benefit of priority from prior Japanese Patent Application No. 2010-191195, filed on Aug. 27, 2010, the entire contents of which are incorporated herein by reference.

### BACKGROUND OF THE INVENTION

The present invention relates to a video projector including a duct that guides air, which is drawn into a housing, to a cooling subject.

Japanese Laid-Open Patent Publication No. 2010-78688 discloses a video projector including a duct that draws ambient air into a housing with an intake fan. The air drawn in flows through the duct and is delivered as a cooling current to a cooling subject, such as a liquid crystal panel or a polarizer. This cools the cooling subject.

In the conventional cooling structure, after cooling the cooling subject, the cooling air strikes a wall in the housing and then spontaneously flows to locations in the housing at where the pressure is negative (lower). However, the cooling efficiency of such a cooling structure is low. In the prior art, no consideration has been made to improve the cooling efficiency by using the cooling current that has cooled the cooling subject the cooling current that has passed by the cooling subject).

### SUMMARY OF THE INVENTION

One aspect of the present invention is a video projector including a housing that accommodates a plurality of cooling subjects and a duct that guides air, which is drawn into the housing, to a predetermined one of the cooling subjects. Cooling current formed from the air is discharged out of the duct to cool the predetermined one of the cooling subjects. A deflector deflects the cooling current after cooling the predetermined one of the cooling subjects toward a further one of the cooling subjects. The deflector is formed by a sound absorbing material.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1(a) is a perspective view showing a video projector according to one embodiment of the present invention;

FIG. 1(b) is a side view showing the video projector of FIG. 1(a);

FIGS. 2 to 4 are schematic diagrams showing the interior structure of the video projector of FIG. 1(a); and

FIGS. 5 to 9 are schematic diagrams showing the flow of cooling current in the video projector.

### DETAILED DESCRIPTION OF THE INVENTION

A projector 1 according to one embodiment of the present invention will now be described.

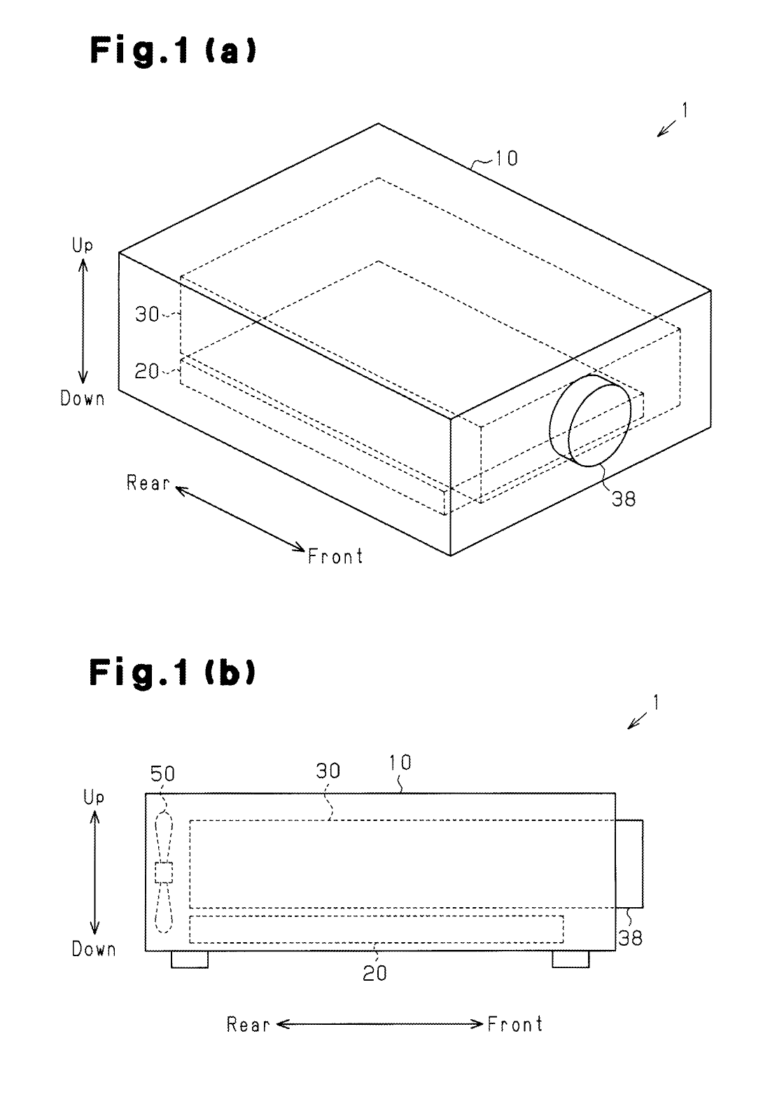

The projector 1 is a video projector that projects and displays an image onto a surface such as a screen or a wall. In the description hereafter, the direction in which the projector 1 projects the light of an image is referred to as a frontward direction. Further, in the description hereafter, upward and downward directions are orthogonal to frontward and rearward directions as shown by the arrows In FIG. 1.

Referring to FIGS. 1(a) and 1(b), the projector 1 includes a housing 10, which accommodates electrical components and optical components. An intake unit 20, an optical system 30, and a fan 50 are arranged in the housing 10. The intake unit 20 forcibly draws ambient air into the housing 10. The optical system 30 includes a plurality of cooling subjects. The fan 50 discharges air out of the housing 10 (refer to FIG. 1(b).

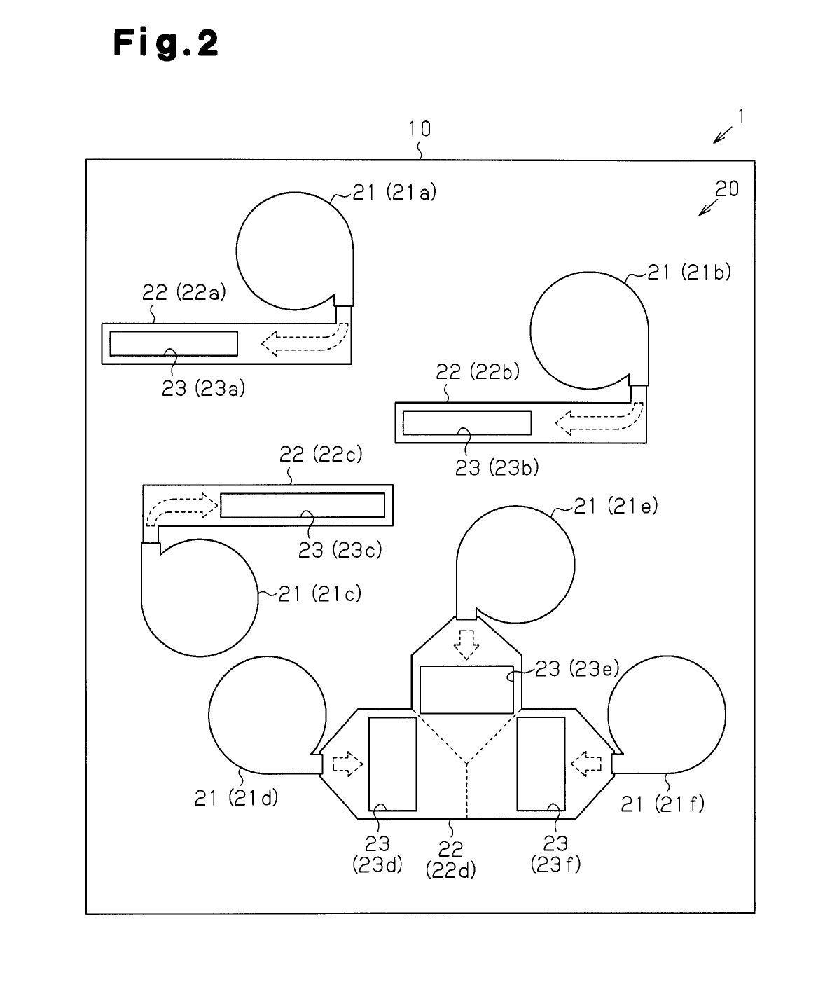

Referring to FIG. 2, the intake unit 20 includes fans 21 and ducts 22. The fans 21 draw ambient air into the housing 10 and generate air currents. The ducts 22 guide the air currents generated by the fans 21 to the cooling subjects.

The fans 21, which are, for example, sirocco fans, may be referred to as intake fans. Further, each fan 21 is connected to the corresponding duct 22 and guides the air drawn into the housing 10 to the duct 22 as a cooling current.

There may be just one fan 21 or a plurality of fans 21. Further, there may be just one duct 22 or a plurality of ducts 22. In the present embodiment, a plurality of fans 21a to 21f are used in correspondence with the plurality of cooling subjects arranged in the housing 10. The fans 21a to 21c are respectively connected to ducts the 22a to 22c, which are discrete components. The fans 21d to 21f are connected to a duct 22d, which is a single component.

Each duct 22 includes an outlet 23. The fans 21 discharge currents of air out of the corresponding outlets 23 as cooling currents. In the present embodiment, the ducts 22a and 22b respectively include outlets 23a and 23b, which are located near cooling subjects. The duct 22c includes an outlet 23c, which is located below a cooling subject. The duct 22d includes a plurality of outlets 23d to 23f, which are located below cooling subjects.

The intake unit 20 discharges cooling currents out of the ducts 22 from the outlets 23 in an upward direction and cools the cooling subjects with the cooling currents. In the present embodiment, the outlets 23c to 23f of the ducts 22c and 22d are located below the cooling subjects and oriented in an upward direction. Thus, cooling currents from the outlets 23c to 23f are discharged straight toward the cooling subjects (predetermined cooling subjects), which are located right above the outlets 23c to 23f. This cools the predetermined cooling subjects.

The optical system 30 will now be described.

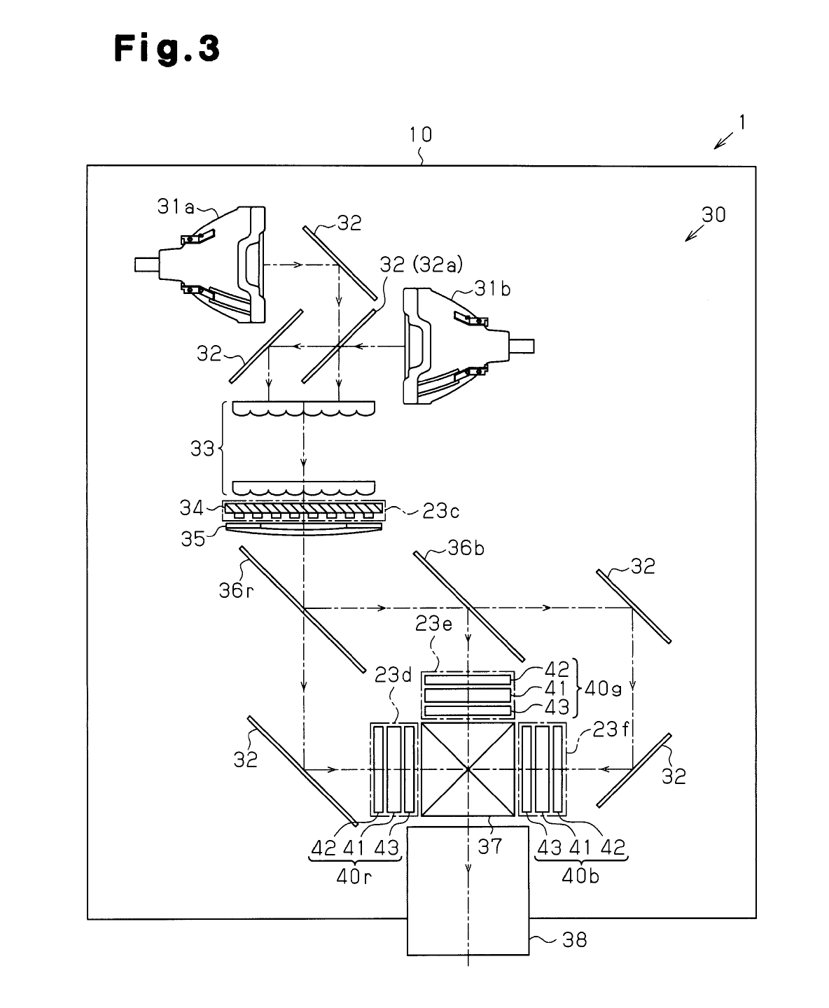

Referring to FIG. 3, the optical system 30 is formed by optical components including lamps 31a and 31b, dichroic mirrors 36r and 36b, and liquid crystal light valves 40r, 40g, and 40b. The lamps 31a and 31b are light sources used to display an image. The dichroic mirrors 36r and 36b separate white light into the three primary colors of light, namely, red, green, and blue. The liquid crystal light valves 40r, 40g, and 40b respectively correspond to the three primary colors of light.

The lamps 31a and 31b may be discharge lamps, such as ultra high pressure mercury lamps or metal halide lamps. The lamps 31a and 31b emit white light. Mirrors 32 guide the light from the lamps 31a and 31b to the liquid crystal light valves 40r, 40g, and 40b.

In the present embodiment, the mirrors 32 include a half mirror 32a, which combines the light emitted from the lamps 31a and 31b. An integrator lens 33, which is formed by two fly's eye lenses, a polarizer 34, and a condenser lens 35 are arranged between the mirrors 32 and the liquid crystal light valves 40r, 40g, and 40b. The integrator lens 33 evens the illuminance distribution of light. The polarizer 34 sets the polarization direction of light to the same predetermined direction. The condenser lens 35 converges light so that the converged light strikes the liquid crystal light valves 40r, 40g, and 40b.

Light having the wavelength corresponding to the color of red passes through the dichroic mirror 36r. Light having the wavelength corresponding to the color of blue passes through the dichroic mirror 36b. The white light from the lamps 31a and 31b is separated by the dichroic mirrors 36r and 36b into light having the wavelength corresponding to the color of red (red light), light having the wavelength corresponding to the color of green (green light), and light having the wavelength corresponding to the color of blue (blue light).

The red light enters the liquid crystal light valve 40r. The green light enters the liquid crystal light valve 40g. The blue light enters the liquid crystal light valve 40b. Each of the liquid crystal light valves 40r, 40g, and 40b has a light transmittance that is variable for each of the pixels'forming a single image. Further, each of the liquid crystal light valves 40r, 40g, and 40b includes a liquid crystal panel 41, a reception side optical component 42 located at the side of the liquid crystal panel 41 that receives light, and an emission side optical component 43 located at the side of the liquid crystal panel 41 that emits light. The liquid crystal panel 41 includes at least transparent substrates that hold liquid crystal molecules in between. The reception side optical component 42 and the emission side optical component 43 each include at least a polarization plate.

The liquid crystal light valve 40r passes red light to generate a red image. The liquid crystal light valve 40g passes green light to generate a green image. The liquid crystal light valve 40b passes blue light to generate a blue image.

The optical components of the optical system 30 further include a cross dichroic prism 37 and a projection lens 38. The cross dichroic prism 37 combines the light of the images of the three primary colors. The projection lens 38 includes a group of lenses that project the light of an image.

The cross dichroic prism 37 combines the light of the red, green, and blue images generated by the liquid crystal light valves 40r, 40g, and 40b. This generates light of a color image having three or more colors like a full color image. The cross dichroic prism 37 then passes the light of the color image to the projection lens 38.

The projector 1 projects from the projection lens 38 the light of an image onto a flat surface such as a screen or wall arranged in front of the projector 1. The projector 1 of the present embodiment is a two-lamp, three-chip type video projector.

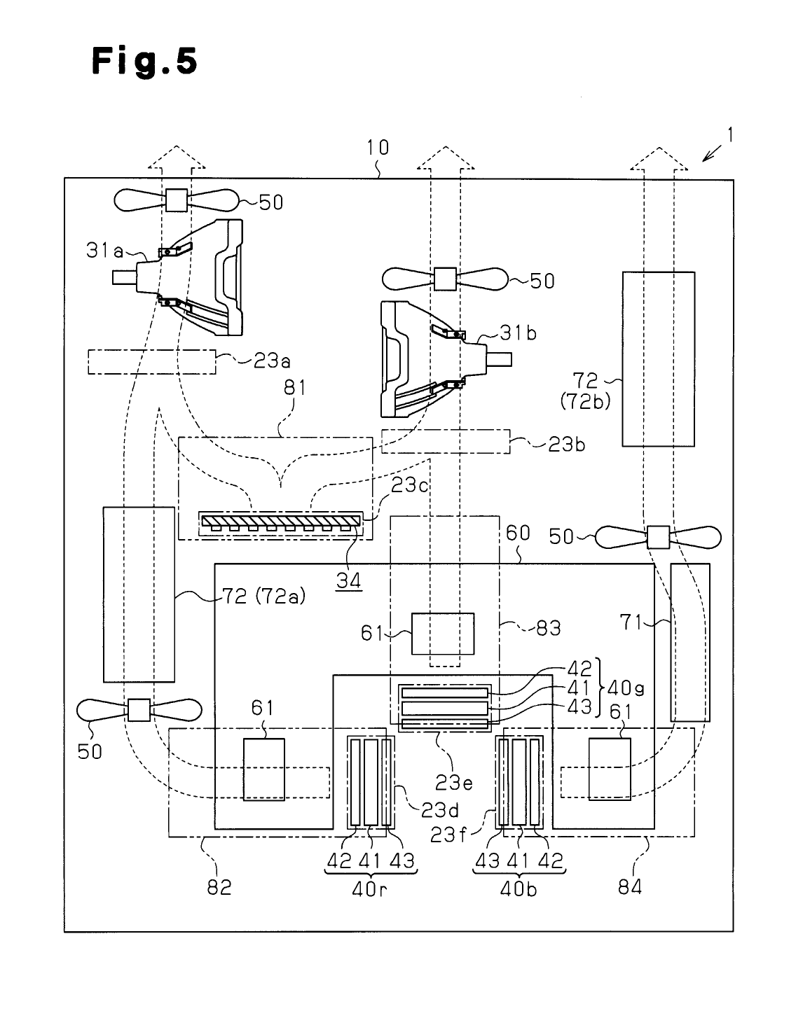

In the present embodiment, the cooling subjects of the projector include the lamps 31a and 31b, the polarizer 34, and the liquid crystal light valves 40r, 40g, and 40b. Referring to FIG. 5, the outlets 23c to 23f, which are oriented upward, are respectively arranged below the polarizer 34 and the liquid crystal light valves 40r, 40g, and 40b.

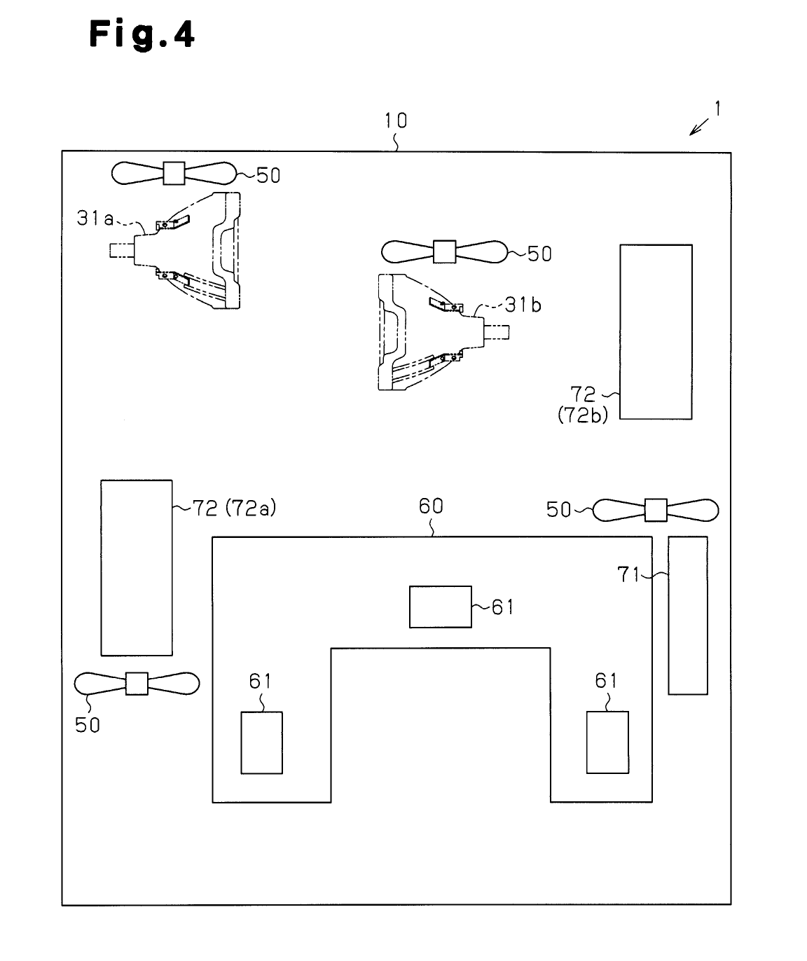

Referring to FIG. 4, the housing 10 accommodates circuit substrates 60, electrical components 61 arranged on each circuit substrate 60, a power supply 71 that supplies power to the electrical components 61, and a lamp power supply 72 that supplies power to the lamps 31a and 31b. The cooling subjects also include the electrical components 61, the power supply 71, and the lamp power supply 72.

The electrical components 61 form circuits that drive the liquid crystal light valves 40r, 40g, and 40b or circuits that process an image signal. The liquid crystal light valves 40r, 40g, and 40b form an electro-optic device. In the present embodiment, the electrical components 61 and the circuit substrates 60 are arranged above the optical system 30. The circuit substrates 60 are separated from the region above each outlet 23.

The power supply 71 and the lamp power supply 72 are electrical components including power supply circuits. Further, the power supply 71 and the lamp power supply 72 are separated from regions located above and below the optical system in the upward and downward directions. In the present embodiment, the lamp power supply 72 may include a lamp power supply 72a that supplies power to the lamp 31a and a lamp power supply 72b that supplies power to the lamp 31b.

The cooling current that has cooled the cooling subjects, that is, the cooling current that has passed by the cooling subjects is forcibly discharged out of the housing 10 by the fan 50. In the present embodiment, the fan 50 may be one of a plurality of fans arranged at a plurality of locations in the housing 10. The fan 50 may be referred to as a relay fan.

With reference to FIGS. 5 to 9, deflectors 81 to 84 arranged in the housing 10 to adjust the direction of the cooling current will now be described. The deflectors 81 to 84 are each formed by a sound absorbing material.

In FIGS. 5 to 9, the arrows formed by broken lines indicate the direction in which cooling currents are directed out of the ducts 22 (refer to FIG. 2).

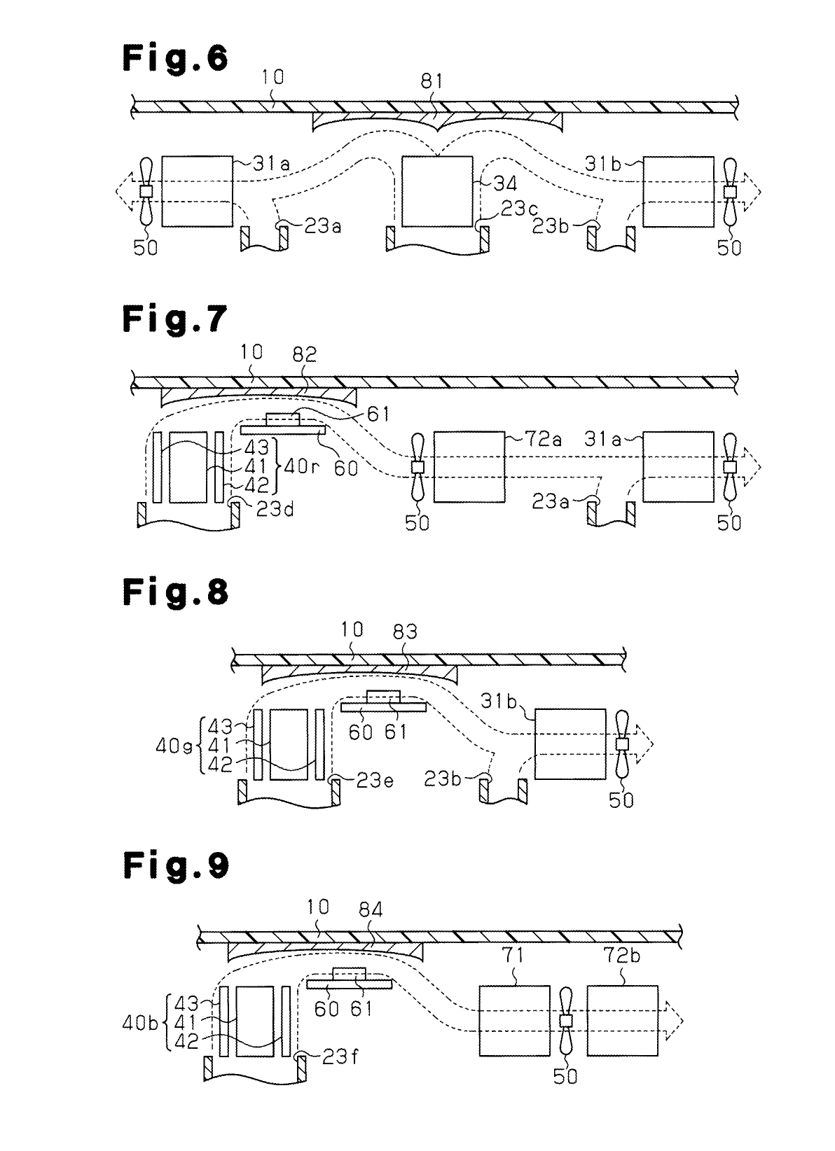

Referring to FIGS. 5 and 6, the deflector 81 is a deflection plate that adjusts the direction of cooling current so that the cooling current that has cooled the polarizer 34, which serves as a predetermined cooling subject, flows toward the lamps 31a and 31b, which are further cooling subjects.

The deflector 81 faces toward the outlet 23c with the polarizer 34 arranged in between. The deflector 81 deflects the cooling current that has been discharged out of the outlet 23c and passed by the polarizer 34 toward the vicinity of the outlets 23a and 23b. In this manner, the deflector 81 adjusts the direction of a cooling current flowing upward to a direction that is substantially orthogonal to the upward and downward directions. In the example of FIG. 6, the deflector 81 has a lower surface including two deflection surfaces.

In the illustrated example, the deflector 81 divides the cooling current directed out of the outlet 23c into two branched cooling currents that are directed toward other cooling subjects, which differ from each other and are located in the downstream direction. More specifically, one of the branched cooling currents of the cooling air directed out of the outlet 23c and deflected by the deflector 81 flows toward the lamp 31a and cooperates with the cooling current discharged out of another outlet 23a to cool the lamp 31a. Another one of the branched cooling currents of the cooling air discharged out of the outlet 23c and deflected by the deflector 81 flows toward the lamp 31b and cooperates with the cooling current discharged out of another outlet 23b to cool the lamp 31b. The cooling currents that have cooled the lamps 31a and 31b are discharged out of the housing 10 by the fans 50. In the flow of cooling air discharged out of the outlet 23c, the polarizer 34 is located at a relatively upstream position, and the lamps 31a and 31b are located at the downstream side of the polarizer 34.

Referring to FIGS. 5 and 7, the deflector 82 is a deflection plate that adjusts the direction of cooling current so that the cooling current that has cooled the liquid crystal light valve 40r, which serves as a predetermined cooling subject, flows toward the lamp power supply 72a and the lamp 31a, which are further cooling subjects.

The deflector 82 faces toward the outlet 23d with the liquid crystal light valve 40r arranged in between. The deflector 82 deflects the cooling current that has been discharged out of the outlet 23d and passed by the liquid crystal light valve 40r toward the negative pressure side (intake side) of a fan 50, which directs the cooling current toward the lamp power supply 72a. In this manner, the deflector 82 adjusts the direction of a cooling current flowing upward to a direction that is substantially orthogonal to the upward and downward directions. In the example of FIG. 7, the deflector 82 has a lower surface that includes a single deflection surface.

The deflection surface of the deflector 82 faces toward the electrical components 61 on a circuit substrate 60. Thus, the cooling current deflected by and flowing along the deflection surface of the deflector 82 cools the electrical components 61 between the deflector 82 and the circuit substrate 60.

The cooling current deflected by the deflector 82 is drawn by the fan 50 and directed toward the lamp power supply 72a. Then, the cooling current cooperates with the cooling current discharged out of another outlet 23a to cool the lamp 31a. The cooling current that has cooled the lamp 31a is discharged out of the housing 10 by the fan 50 as described above. In the flow of cooling air discharged out of the outlet 23d, the liquid crystal light valve 40r is located at a relatively upstream position, and the electrical components 61, the lamp power supply 72a, and the lamp 31a are located at the downstream side of the liquid crystal light valve 40r.

Referring to FIGS. 5 and 8, the deflector 83 is a deflection plate that adjusts the direction of cooling current so that the cooling current that has cooled the liquid crystal light valve 40g, which serves as a predetermined cooling subject, flows toward the lamp 31b, which is a further cooling subject.

The deflector 83 faces toward the outlet 23e with the liquid crystal light valve 40g arranged in between. The deflector 83 deflects the cooling current that has been discharged out of the outlet 23e and passed by the liquid crystal light valve 40g toward the vicinity of the outlet 23b. In this manner, the deflector 83 adjusts the direction of a cooling current flowing upward to a direction that is substantially orthogonal to the upward and downward directions. In the example of FIG. 8, the deflector 83 has a lower surface including a single deflection surface.

The deflection surface of the deflector 83 faces toward the electrical components 61 on a circuit substrate 60. Thus, the cooling current deflected by and flowing along the deflection surface of the deflector 83 cools the electrical components 61 between the deflector 83 and the circuit substrate 60.

The cooling current deflected by the deflector 83 cooperates with the cooling current discharged out of the outlet 23b to cool the lamp 31b. The cooling current that has cooled the lamp 31b is discharged out of the housing 10 by the fan 50 as described above. In the flow of cooling air discharged out of the outlet 23e, the liquid crystal light valve 40g is located at a relatively upstream position, and the electrical components 61 and the lamp 31b are located at the downstream side of the liquid crystal light valve 40g.

Referring to FIGS. 5 and 9, the deflector 84 is a deflection plate that adjusts the direction of cooling current so that the cooling current that has cooled the liquid crystal light valve 40b, which serves as a predetermined cooling subject, flows toward the power supply 71 and the lamp power supply 72b, which are further cooling subjects.

The deflector 84 faces toward the outlet 23f with the liquid crystal light valve 40b arranged in between. The deflector 84 deflects the cooling current that has been discharged out of the outlet 23f and passed by the liquid crystal light valve 40b toward the negative pressure side (intake side) of the fan 50 that draws the cooling current toward the lamp power supply 72a. In this manner, the deflector 84 adjusts the direction of a cooling current flowing upward to a direction that is substantially orthogonal to the upward and downward directions. In the example of FIG. 9, the deflector 84 has a lower surface that includes a single deflection surface.

The deflection surface of the deflector 84 faces toward the electrical components 61 on a circuit substrate 60. Thus, the cooling current deflected by and flowing along the deflection surface of the deflector 84 cools the electrical components 61 between the deflector 84 and the circuit substrate 60.

The cooling current deflected by the deflector 84 cools the power supply 71. Then, the fan 50 draws the cooling current toward the lamp power supply 72b. This cools the lamp power supply 72b. Afterward, the cooling current is discharged out of the housing 10. In the flow of cooling air discharged out of the outlet 23f, the liquid crystal light valve 40b is located at a relatively upstream position, and the electrical components 61, the power supply 71, and the lamp power supply 72b are located at the downstream side of the liquid crystal light valve 40b.

As described above, the deflectors 81 to 84 improve the cooling efficiency of the lamps 31a and 31b, the electrical components 61, the power supply 71, and the lamp power supplies 72a and 72b.

The deflectors 81 to 84 each are formed by a sound absorbing material. A non-limited example of the sound absorbing material is a resin foam. The resin foam may be urethane foam, which is electrically insulative. The deflectors 81 to 84 have higher sound absorbency than the housing 10, which is formed from a synthetic resin such as acrylonitrile butadiene styrene (ABS). In the present embodiment, the deflectors 81 to 84 are fixed by an adhesive tape (not shown) to the housing 10.

In the illustrated example, the deflection surfaces of the deflectors 81 to 84 are inwardly curved surfaces. An inwardly curved deflection surface deflects a cooling current flowing in an upward direction to a sideward and slightly downward direction.

The present embodiment has the advantages described below.

x(1) The projector 1 includes the deflectors 81 to 84, which deflect cooling currents that have cooled predetermined cooling subjects toward other cooling subjects. Further, the deflectors 81 to 84 are formed by a sound absorbing material. Thus, in comparison to when there are no deflectors 81 to 84, cooling current flows more easily from a predetermined cooling subject to another cooling subject. This improves the cooling efficiency. Further, the sound absorbing material forming the deflectors 81 to 84 produces less noise when cooling current strikes the deflectors 81 to 84 compared to when the deflectors 81 to 84 are formed from a material that does not absorb sound.

x(2) The deflectors 81 to 84 are arranged facing toward the corresponding outlets 23c to 23f with the predetermined cooling subjects located in between. Thus, the cooling currents discharged out of the ducts 22c and 22d from the outlets 23c to 23f and passed by the predetermined cooling subjects are easily deflected with simple structures.

x(3) The deflectors 81 to 84 have a higher sound absorbency than the housing 10. This reduces the noise produced when cooling current directly strikes the housing 10.

x(4) The cooling subjects arranged at the downstream side of the predetermined cooling subjects in the flow of cooling current include the lamps 31a and 31b. This improves the cooling efficiency of the lamps 31a and 31b, which are easily heated.

x(5) The cooling subjects arranged at the downstream side of the predetermined cooling subjects in the flow of cooling current include electrical components (i.e., the electrical components on the circuit substrates, the power supply 71, and the lamp power supply 72). This improves the cooling efficiency of the electrical components. In particular, the present embodiment includes the lamps 31a and 31b in addition to the electrical components 61 on the circuit substrate 60. Thus, the cooling efficiency of each part in the housing 10 is improved.

x(6) The deflectors 81 to 84 are formed by resin foams. This reduces the weight of the deflectors 81 to 84. Further, the electrical insulation of the resin foams prevent the electrical circuits in the housing 10 from being short-circuited when contacting-the deflectors 81 to 84.

x(7) The deflectors 81 to 84 are non-electrical stationary components that deflect currents without electrical power. Thus, the cooling efficiency of each part in the housing 10 is effectively improved without increasing the power consumption of the projector 1.

x(8) In the illustrated example, the deflectors 81 to 84 are plates fixed to the lower surface of a top wall of the housing 10. Thus, the deflectors 81 to 84 occupy a relatively small amount of space in the vertical direction. This improves the cooling efficiency of each part in the housing 10 without significantly decreasing the interior volume of the housing 10.

It should be apparent to those skilled in the art that the present invention may be embodied in many other specific forms without departing from the spirit or scope of the invention. Particularly, it should be understood that the present invention may be embodied in the following forms.

The quantity and layout of the fans 21 may be changed. Further, the quantity, shape, and layout of the ducts 22 may be changed. The quantity, shape, and layout of the outlets 23 may also be changed. Moreover, the quantity of the fans 21 does not have to be the same as the quantity of the outlets 23.

In the above embodiment, the deflectors 81 to 84 are fixed to the housing 10 by an adhesive tape. However, the deflectors 81 to 84 may be arranged on elements other than the housing 10. Further, the means for fastening the deflectors 81 to 84 is not limited to the adhesive tape.

The sound absorbing material forming the deflectors 81 to 84 may be changed. For example, the sound absorbing material may be formed of a material other than urethane or a material in which fibers are woven and air is contained. That is, the material for forming the deflectors 81 to 84 is not limited to that of the above embodiment as long as it absorbs sound.

The quantity, layout, shape, and the like of the deflectors 81 to 84 may be changed. In the above embodiment, the projector 1 includes the four deflectors 81 to 84. However, the quantity of the deflectors in the projector 1 is not limited to the quantity in the above embodiment. Further, the shape of the deflectors is not limited to the shape in the above embodiment as long as the direction of currents can be adjusted as described above.

The cooling subjects are not limited, as described in the above embodiment, to the liquid crystal light valves 40r, 40g, and 40b, the lamps 31a and 31b, the polarizer 34, the electrical components 61, the power supply 71, and the lamp power supplies 72a and 72b. The present invention may also be applied when other cooling subjects are cooled.

The present invention is neither limited to a three-chip liquid crystal projector nor a two-lamp video projector. For example, the present invention may be applied to a projector including a digital micromirror device (DMD) as the electro-optic device. Further, the present invention may be applied to a video projector including one lamp or three or more lamps.

The present examples and embodiments are to be considered as illustrative and not restrictive, and the invention is not to be limited to the details given herein, but may be modified within the scope and equivalence of the appended claims.

1. A video projector comprising:
a housing that accommodates a plurality of cooling subjects;
a duct that guides air, which is drawn into the housing, to a predetermined one of the cooling subjects, wherein cooling current formed from the air is discharged out of the duct to cool the predetermined one of the cooling subjects; and
a deflector that deflects the cooling current after cooling the predetermined one of the cooling subjects toward a further one of the cooling subjects, wherein the deflector is formed by a sound absorbing material.

2. The video projector according to claim 1, wherein
the duct includes an outlet from which the cooling current is discharged and the duct is oriented toward the predetermined one of the cooling subjects, and
the deflector is arranged facing toward the outlet with the predetermined one of the cooling subjects located between the deflector and the outlet.

3. The video projector according to claim 1, wherein the deflector has a higher sound absorbency than the housing.

4. The video projector according to claim 1, wherein the further one of the cooling subjects includes a lamp used to display an image.

5. The video projector according to claim 1, wherein the further one of the cooling subjects includes an electrical component.

6. The video projector according to claim 1, wherein the sound absorbing material is resin foam.

7. The video projector according to claim 1, wherein the deflector is a non-electric-powered stationary component and deflects an air current without electric power.

8. The video projector according to claim 1, wherein the deflector is a plate fixed to a lower surface of a top plate of the housing.

9. The video projector according to claim 2, wherein
the outlet of the duct is located right below the predetermined one of the cooling subjects,
the deflector includes one or more deflection surfaces located right above the predetermined one of the cooling subjects, and
the further one of the cooling subjects includes a downstream cooling subject located at a position separated from right above the outlet of the duct and from right below the one or more deflection surfaces.

10. The video projector according to claim 9, wherein the further one of the cooling subjects further includes an electrical component arranged on a circuit substrate and located at a position right below the one of more deflection surfaces but separated from right above the outlet of the duct.

11. A video projector comprising:
a housing that accommodates a first predetermined cooling subject and a second predetermined cooling subject;
a duct that guides air, which is drawn into the housing, to the first predetermined cooling subject, wherein cooling current formed from the air is discharged out of the duct to cool the first predetermined cooling subject; and
a deflector arranged in the housing and including a deflection surface that is shaped to deflect the cooling current after cooling the first predetermined cooling subject toward the second predetermined cooling subject to cool the second predetermined cooling subject, wherein the deflector is formed by a sound absorbing material.

12. The video projector according to claim 11, wherein the sound absorbing material is resin foam.

13. The video projector according to claim 11, wherein the deflector is a non-electric-powered stationary plate fixed to a lower surface of a top plate of the housing.
